(19) United States
(12) Patent Application Publication
(10) Pub. No.: US 2004/0262425 A1
(43) Pub. Date: Dec. 30, 2004

(54) Slip-stop device for preventing slipping of vehicle wheels

(76) Inventors: Moriharu Sakai, Kariya (JP); Takashi Watanabe, Nagoya (JP); Shoichi Masaki, Chiryu (JP)

Correspondence Address: BURNS DOANE SWECKER & MATHIS L L P, POST OFFICE BOX 1404, ALEXANDRIA, VA, 22313-1404, US

(21) Appl. No.: 10/873,229

(22) Filed: Jun. 23, 2004

(30) Foreign Application Priority Data
Jun. 26, 2003 (JP) 2003-183122

(51) Int. Cl. B05B 12/08

(52) U.S. Cl. 239/128; 239/63

(57) ABSTRACT

A slip-stop device to be mounted on a vehicle is proposed. It includes a tank in which is stored a liquid. The liquid is heated by a heater. A control unit detects the temperature of the road surface on which the vehicle is traveling based on temperature information from temperature sensors to determine whether the road surface is frozen, and whether a particular wheel of the vehicle is slipping. If it determines that the road surface is frozen and the wheel is slipping, the control unit activates a motor-driven pump to spray heated liquid on the frozen road to melt the ice covering the road, thereby increasing the roughness of the road surface. The liquid should be non-freezing liquid such as water that has been subjected to non-freezing treatment or alcohol.

### BACKGROUND OF THE INVENTION

This invention relates to a slip-stop device for preventing slipping of vehicle wheels by dispersing, on a frozen or otherwise slippery road surface, a medium that will not harm the environment even though it remains on the road surface, such as water, sand or seeds, thereby increasing the roughness of the otherwise smooth and slippery frozen road surface.

In winter times, when the ambient temperature drops below the freezing point, snow-covered or otherwise wet road surfaces freeze. The friction coefficient μ between such a frozen road surface and road wheels of a vehicle traveling on such a frozen road surface is extremely low, so that the vehicle can hardly travel stably on such a road surface even at a low speed. Various measures have been proposed and implemented to directly increase the μ value of such low-μ road surfaces. Such measures include the use of a “slip-stop assisting device for a vehicle” as disclosed in JP patent publication 8-25905. This device includes means for heating a slip-stop granular substance stored in a tank, and means for spraying the heated slip-stop granular substance on the road surface immediately before the respective road wheels pass thereon.

When the thus heated slip-stop grains are sprayed on the road surface, they instantly melt the ice covering the road and get stuck in the ice. Immediately thereafter, water melted by the hot grains re-freezes, holding the grains rigidly in the ice with the grains partially sticking out of the road surface. This increases the roughness of the road surface and thus its μ value. Granular materials used for this purpose include organic substances such as sand and thawing materials, and organic substances such as vegetable seeds, edible powder, and resin grains.

Besides spraying a granular substance on a road surface as disclosed in the above patent publication, the roughness of a frozen or otherwise slippery road surface can also be increased by e.g. partially melting or scratching ice covering the road using pressurized and/or heated water, light or air.

The arrangement that uses granular substances has a drawback in that grains of sand or seeds in the tank tend to absorb water and stick together into lumps in the long run, making it impossible to spray them at all. The latter arrangement is free of this problem.

We, the inventors of the present invention, discovered that in either arrangement, it is necessary only when the road surface is frozen, and is otherwise not desirable, to spray granular substances or apply pressure or heat in the form of water, light or air. As a result, we discovered that it would be desirable to determine whether the road surface is frozen or not, and to spray granular materials or apply heat or pressure only if determination is made that the road is actually frozen to increase the roughness of the road surface only when this is indeed necessary. It is believed that anyone skilled in the art has never before proposed a method or a device that realizes such a concept.

An object of the present invention is to provide a slip-stop device for a vehicle which is adapted to spray a liquid or granular material on a frozen road surface only if it is necessary to increase the friction coefficient between the road surface and wheels of the vehicle by spraying such a liquid or granular material.

### SUMMARY OF THE INVENTION

According to this invention, there is provided a slip-stop device for a vehicle comprising a tank in which is stored a liquid, a heater for heating the liquid in said tank to a high temperature, a sprayer provided near a road wheel of the vehicle for spraying the high-temperature liquid in discontinuous flows or droplets, a sensor unit for producing signals indicating the state of a road surface on which the vehicle is traveling, and a control unit for controlling said heater and said sprayer, said control unit being arranged to determine whether the road surface is frozen based on the signals from said sensor unit and, if the road surface is determined to be frozen, activate said sprayer to spray the high-temperature liquid on the road surface, thereby increasing the roughness of the road surface.

Instead of the heater or in addition to the heater, the slip-stop device may include a pressurizing unit for pressuring the liquid in the tank before spraying the liquid.

Preferably, the liquid in the tank is heated to a predetermined temperature and/or pressurized to a predetermined pressure immediately after the engine has been started and before the vehicle starts. The liquid stored in the tank may be water to which is added an anti-freezing agent to make the water non-freezable, or any other non-freezing liquid such as alcohol.

If the control unit detects that the vehicle is traveling on a frozen road surface, and that the wheel is slipping based on signals from various sensors that indicate behaviors of the vehicle, particularly its wheel, such as a wheel speed sensor, an acceleration sensor, a yaw rate sensor and a brake pedal sensor, the control unit activates the sprayer to spray the pressurized and/or heated liquid in discontinuous flows or droplets on the ice covering the road surface, thereby melting and/or scraping the ice and increasing the roughness of the frozen road surface. The liquid is sprayed on the road surface over an area slightly wider than the tread of the wheel tire in front of the wheel with respect to the traveling direction of the vehicle. The control unit detects whether the wheel is slipping based on signals from a single sensor or a plurality of sensors.

Snow-covered or otherwise wet road surfaces freeze when the ambient temperature drops below the freezing point and will remain frozen for a while even after the ambient temperature has risen above the freezing point. Thus, in the present invention, if the ambient temperature and the road surface temperature are near the freezing point, the control unit is adapted to prepare to spray the liquid.

If the ambient temperature is well above the freezing point, the road surface cannot freeze and it is not necessary to activate the present system. Thus, in such a case, the heater and/or the pressurizing unit is deactivated to save energy.

In determining whether the road surface is frozen, in addition to the temperature information, the friction coefficient μ, as measured based on signals from a wheel speed sensor and an acceleration sensor, may be used.

The friction coefficient between the wheel of the vehicle and the road surface can be measured by detecting whether the wheel tire is vibrating at a frequency in the resonance frequency range.

### BRIEF DESCRIPTION OF THE DRAWINGS

Other features and objects of the present invention will become apparent from the following description made with reference to the accompanying drawings, in which:

FIG. 1 is a schematic view of a slip-stop device for a vehicle of a first embodiment of the present invention;

FIG. 2 is a schematic block diagram of a control circuit of the device of FIG. 1;

FIG. 3 is a flowchart of the control carried out in the control circuit of FIG. 2; and

FIG. 4 is a schematic view of a slip-stop device for a vehicle of a second embodiment.

### DETAILED DESCRIPTION OF THE PREFERRED EMBODIMENT

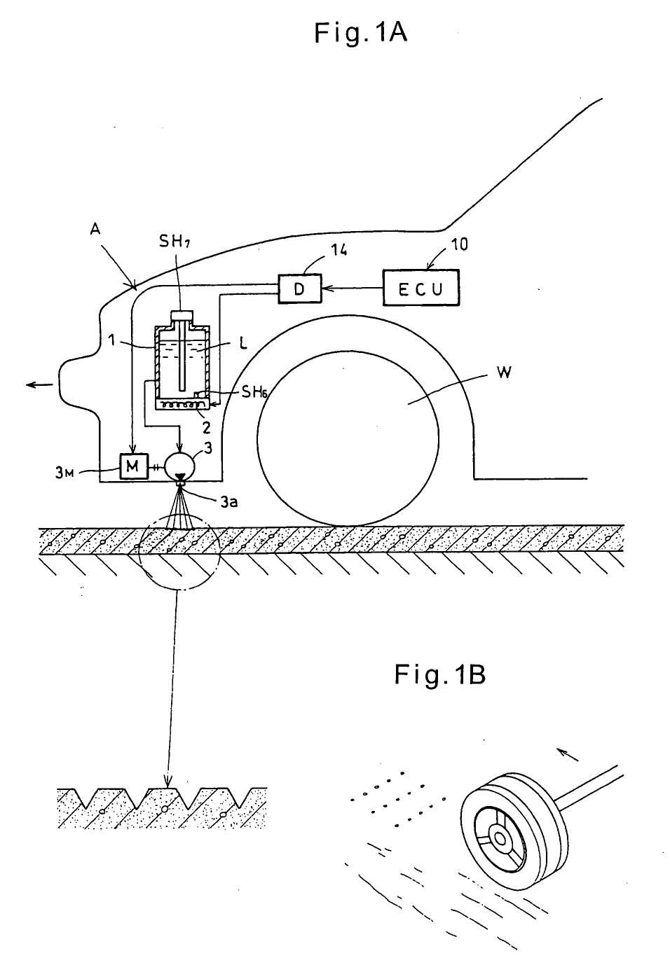

Now the slip-stop device for preventing slipping of wheels of a vehicle embodying the present invention will be described. First referring to FIG. 1, the slip-stop device A includes a tank 1 in which is stored a liquid L. In the tank 1, a heater means for heating the liquid L to a high temperature is provided. The heater means of the embodiment is a heating coil 2 that produces heat using electrical resistance. The heated liquid L is sucked by an injection pump 3 through a pipe.

The injection pump 3 is driven by an electric motor 3_{M}. The heating coil 2 and the motor 3_{M} are controlled by a control circuit 10 (electronic control unit; ECU) through a driver circuit 14. A liquid level sensor SH₇ and a liquid temperature sensor SH₆ are provided that produce signals indicating the liquid level and the liquid temperature, respectively. The signals from these sensors SH₇ and SH₆ are entered into the control circuit 10. Signals from various other sensors, including an ambient temperature sensor and a road surface temperature sensor, are also entered into the control circuit 10. Based on these signals, the control circuit 10 determines whether to actuate the injection pump 3 to spray hot liquid onto the road surface.

The control circuit 10 is programmed to energize the heating coil 2 in the tank 1 to maximum power whenever the ignition switch is turned on and the engine is started while the signal from the ambient temperature sensor is indicating that the ambient temperature is below a predetermined level (e.g. 5° C.), to rapidly heat the liquid to a predetermined high temperature. On exactly how this is done, description is made later.

In the embodiment, the heating coil 2 is mounted in the tank 1. But instead of the heating coil 2, or in addition to the coil 2, exhaust heat produced in the engine of the vehicle may be fed into a hollow pipe running along the inner surface (or outer surface) of the tank 1 to heat the liquid in the tank. The liquid L in the tank 1 is water to which is added an anti-freezing agent to make the water non-freezable, or any other non-freezing liquid such as alcohol. It is necessary to select a liquid that will not harm the environment even if it remains on road surfaces for a long time after being sprayed. Before sprayed, the liquid should be heated to a temperature slightly (several degrees) lower than its boiling point. For example, water is heated to a temperature slightly lower than 100° C., and an alcohol is heated to 60-200° C. according to the type.

The injection pump 3 may be a vane pump, a plunger pump or of any other type. At its discharge port, it is necessary to provide means that allows the liquid to be discharged at a predetermined constant rate in the form of discontinuous flows or droplets, such as a small nozzle cap 3a, so that the hot water sprayed can melt the ice covering the road surface e.g. in a dotted pattern. In the drawings and the specification, only the motor, the pump and its nozzle cap corresponding to one of a plurality of vehicle wheels are shown and described. But it is to be understood that similar motors, pumps and nozzle caps may be provided corresponding to the other vehicle wheels. The nozzle cap 3a preferably has a plurality of nozzle holes that are aligned in the width direction of the tire.

The pump may not be of a high-pressure type but has to be at least capable of spraying hot liquid onto the road surface in the form of discontinuous flows or droplets. For example, a pump having a discharge pressure of several atms would serve as the pump 3. The nozzle cap 3a should be arranged such that the liquid is discharged in front of the tire with respect to the travel direction of the vehicle, but does not necessarily have to be discharged immediately in front of the tire.

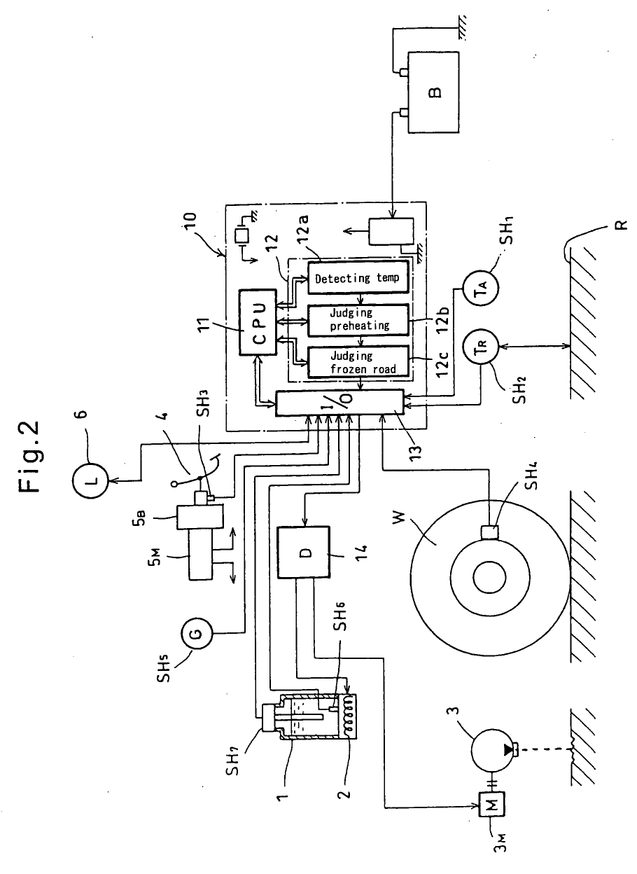

FIG. 2 schematically shows the block diagram of the control circuit 10. As shown, to the control circuit 10, besides signals from the abovementioned temperature sensor SH₆ and liquid level sensor SH₇, signals from ambient temperature sensor SH₁, road surface temperature sensor SH₂, a braking pedal sensor (switch) SH₃ that indicates that the brake pedal has been depressed, a wheel speed sensor SH₄, and an acceleration (deceleration) sensor SH₅ are also entered into the control circuit 10. The brake system shown includes a booster 5_{B} and a master cylinder 5_{M}. Also shown in the drawings is a display device 6.

The control circuit 10 shown is a microcomputer comprising a processor (central processing unit; CPU) 11 for performing various operations based on input data and outputting control signals through its IO (input/output) port 13, a fixed memory 12 that contains various control programs, and a temporary memory in which are entered external data. The temporary memory is not shown for simplicity of the drawings. The fixed memory 12 contains a program for giving an alarm if the amount of the liquid in the tank 1 drops below a predetermined level, and a basic control program for driving the injection pump 3.

The memory 12 further contains a program 12a that allows the CPU to detect temperatures based on signals from the temperature sensors SH₁, SH₂ and SH₆, and a program 12b that allows the CPU to determine whether or not to preheat the tank 1 based on the temperature detected based on the signal from the temperature sensor SH₁. When the CPU determines that it is necessary to preheat the tank 1, the CPU energizes the heating coil 2 to rapidly preheat the liquid L in the tank 1 to a predetermined high temperature.

The tank 1 is preheated before the vehicle starts. The memory 12 further contains a program 12c that allows the CPU to determine, after the vehicle has started, whether or not the road surface on which the vehicle is traveling is frozen based on the signal from the road surface temperature sensor SH₂. If it is determined that the road surface is frozen and that the wheel is slipping severely based on signals from the wheel speed sensor SH₄ and the acceleration sensor SH₅, the CPU drives the motor 3_{M} for the injection pump 3 through the driver circuit 14 to spray hot liquid. These steps will be described in detail later with reference to the flowcharts.

The sensor SH₂ is a non-contact type, which produces signals that indicate the road surface temperature without physically contacting the road surface. The other two temperature sensors SH₆ and SH₁ are ordinary contact type sensors. Any of them picks up information on temperatures, and produces electric signals indicating such temperature information, which are entered into the control circuit 10. The non-contact temperature sensor SH₂ picks up infrared rays emitted from the road surface and produces temperature signals based thereon. For this purpose, the sensor SH₂ includes a quantum infrared pickup element.

Quantum infrared pickups include photoconductive pickups, which are made of e.g. PbS or PbSe and adapted to pick up infrared rays using the photoconductive effect, in which the resistance decreases when exposed to incoming infrared rays, and photovoltaic type pickups, which comprise a semiconductor board made of e.g. Ge, In or Sb and are adapted to produce photovoltaic force when exposed to infrared rays. Either of these two types may be used for the sensor as long as it can accurately distinguish between temperatures below and above the freezing point of the road surface without physically contacting the road surface while moving thereover.

Based on signals from the wheel speed sensor SH₄ and the acceleration sensor SH₅, the CPU determines whether the vehicle is moving or not and if moving, whether it is accelerating or decelerating. These signals are also partially used to determine whether the road surface is frozen. As with many modern cars, if the vehicle is equipped with an antilock brake system (ABS), the wheel speed sensor and the acceleration sensor for the ABS may be used as the sensors SH₄ and SH₅ of the present invention. Based on signals from the brake pedal sensor SH₃, wheel speed sensor SH₄ and acceleration sensor SH₅, the CPU determines whether the road wheel is slipping and activates the injection pump 3 if the wheel is determined to be slipping severely. The brake pedal sensor SH₃ may be a sensor that produces a sensor signal indicating the force applied to the pedal or the stroke of the pedal. Instead of such a brake pedal sensor, the brake hydraulic pressure may be directly picked up with a pressure sensor.

When the injection pump 3 is activated while the vehicle is traveling, the hot liquid in the tank 1 is sprayed through the nozzle holes of the nozzle cap 3a onto the frozen road surface to melt the ice on the frozen road surface, thereby forming numerous holes or apertures in the ice. If the ambient temperature is below a predetermined level or if a manual switch is turned on, as soon as the ignition key (not shown) is turned on, the control circuit 10 will energize the heating coil 2 to quickly preheat the liquid in the tank 1 to a predetermined high temperature so that the slip-stop device A can start up immediately after the vehicle starts.

After the vehicle has started, if the control circuit detects that the wheel is severely slipping on a frozen road, it applies a control signal to the driver circuit 14 to activate the pump. But if the ambient temperature as measured by the ambient temperature sensor SH₁ is higher than a predetermined level, the heater and the pump 3 will not be activated to save electric power.

The control circuit 10 drives the motor 3_{M} through the driver circuit 14 to spray high-temperature liquid through the injection pump 3 onto the road surface in discontinuous flows or droplets to form numerous recesses in the ice covering the road surface. Of course, these recesses have to be formed on the road surface before the tire of the road wheel passes thereon along the path on which the road wheel is supposed to pass. The area of the road surface where such recesses are formed is preferably slightly wider than the tread of the tire.

By forming such recesses in the frozen road surface, the friction coefficient μ between such a road surface and the wheel greatly increases. This in turn greatly improves braking efficiency.

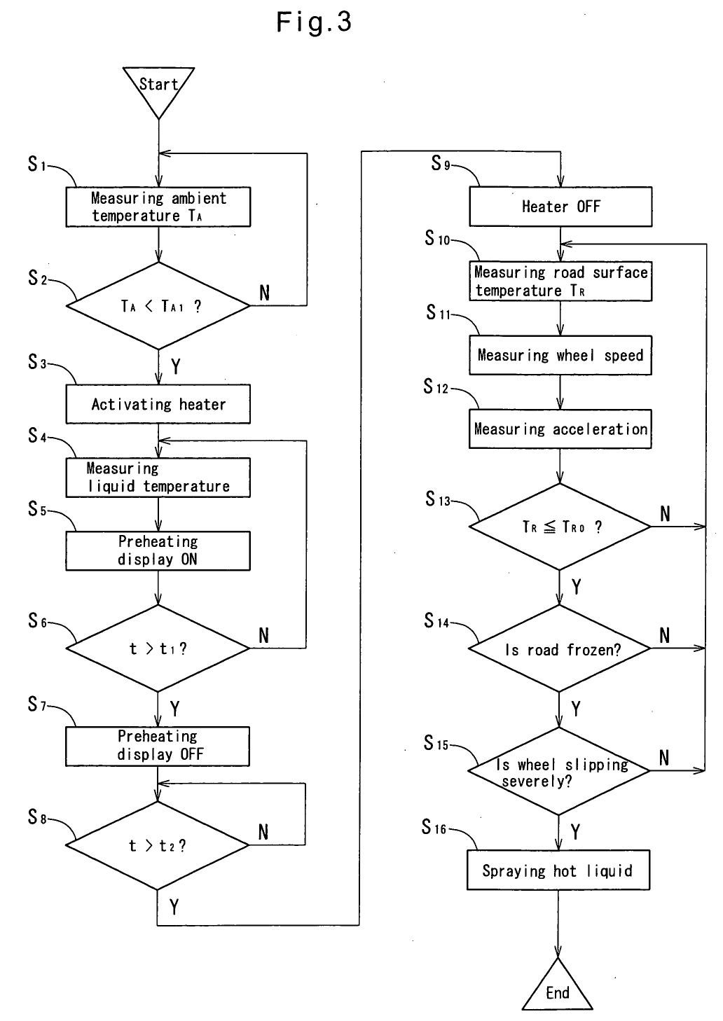

More detailed description will be made on how the slip-stop device of the present invention operates with reference to the flowchart of FIG. 3. As soon as the ignition switch is turned on, the control circuit 10 is activated and begins to measure temperatures based on signals from the temperature sensors SH1, SH₂ and SH₆. That is, in step S1, the control circuit 10 measures the ambient temperature T_{A} based on the signal from the temperature sensor SH₁ and compares the temperature T_{A} with a threshold temperature T_{A1} (which is e.g. 0° C. or 5° C.) to determine whether the former is higher than the latter. If the ambient temperature TA is higher than the threshold T_{A1}, the control circuit determines that the road surface is not frozen and the program returns to the start and repeat these steps. If the ambient temperature TA is not higher than the threshold T_{A1}, the control circuit determines that the road surface is probably frozen, and starts the preheating steps beginning with S3.

But even if the ambient temperature T_{A} is 0° C. or lower, the road surface may not necessarily be frozen. Conversely, even if the ambient temperature is e.g. 5° C., ice may remain not melted on the road surface because the temperature was below zero only a short time before. Thus, a manual switch may be provided to override the judgment of the control circuit that the road surface is frozen or not frozen.

In step S3, the control circuit 10 activates the heating coil 2 through the driver circuit 14 to heat the liquid L in the tank 1. In step S4, the control circuit measures the temperature of the liquid L in the tank 1 through the temperature sensor SH₆. In step S6, the control circuit indicates that the liquid L is being preheated on the display 6. In step S6, the control circuit determines whether the liquid temperature t has exceeded a first threshold temperature t₁, and repeats these steps if this is not the case. When the liquid temperature t exceeds the first threshold t₁, the display 6 is turned off in step S7.

In step S8, the control circuit determines whether the liquid temperature t has exceeded a second threshold temperature t₂, which is substantially equal to or higher than the first threshold t₁. If not, the control circuit repeats this step. When the liquid temperature t has exceeded the second threshold t₂, the control circuit deactivates the heating coil 2.

While not shown in FIG. 3, after the heating coil 2 has been deactivated, when the liquid temperature t drops below the first threshold t₁, the control circuit reactivates the coil 2 until the liquid temperature t exceeds the second threshold t₂ and then deactivates the coil. Thus, in order to prevent the coil from being repeatedly activated and deactivated too frequently, the difference between the threshold values t₁ and t₂ is preferably set sufficiently large (e.g. Δt=t₂−t₁>5 degrees Celsius).

When the liquid has been heated sufficiently, the device is now ready to spray the liquid. In this state, in step S10 and following steps, the control circuit determines whether the road surface is frozen. In S10, the control circuit measures the temperature of road surface T_{R} based on the signal from the temperature sensor SH₂. In S11, it measures the rotating speed of the wheel based on the signal from the wheel speed sensor SH₄, and in S12, it determines whether the vehicle is moving or not and if moving, whether the vehicle is accelerating or decelerating. The order in which these steps are carried is not limited. In step S13, the control circuit compares the road surface temperature measured with a threshold T_{R0} (e.g. 0° C.). In step S14, the control circuit determines whether the road surface is frozen based on the program 12c.

If the road surface temperature T_{R} is 0° C. or lower, the control circuit determines that the road surface is probably frozen. If it further determines that the wheel is slipping in S14, the control circuit concludes that the road surface is indeed frozen. The control circuit determines that the wheel is slipping severely if the wheel speed, as measured through the wheel speed sensor SH4, is higher than a predetermined reference speed (e.g. several kilometers per hour), and the vehicle acceleration, as measured through the acceleration sensor SH₅, is changing at a predetermined rate or higher.

But even if the road surface temperature is 0° C. or lower, if the control circuit detects that the wheel is not slipping in step S14, the control circuit determines that the road surface is not frozen, irrespective of whether the brakes are being applied or not. That is, while the brakes are being applied, as long as the wheel speed is decreasing rapidly and the vehicle is decelerating substantially corresponding to the falling wheel speed, the control circuit determines that the wheel is not slipping and thus the road surface is not frozen.

Conversely, while the brakes are being applied, if the vehicle deceleration is substantially low compared to the falling wheel speed, the control circuit determines that the wheel is slipping and thus the road surface is frozen. If the control circuit determines negative in either of the steps S13 and S14, the program instantly returns to step S10. If the control circuit determines in S14 that the road surface is frozen, it determines whether the wheel slip is severe based on signals from the brake pedal sensor SH₃, wheel speed sensor SH₄, acceleration sensor SH₅ in S15. Only if the control circuit determines that the wheel slip is severe in S15, it actuates the motor 3_{M} to spray high-temperature liquid from the pump 3 in the form of discontinuous flows or droplets in step S16.

Such discontinuous flows or droplets may be sprayed at equal, predetermined intervals irrespective of whether the vehicle has started, is traveling at a constant speed, or is being braked. But instead, the intervals of such discontinuous flows or droplets may vary depending on \mathring{1} whether the vehicle has started, \mathring{2} the vehicle is being brought to a stop by applying the brakes, \mathring{3} the vehicle is traveling with the brakes not applied, or \mathring{4} the brakes are being mildly applied. Specifically, in the cases of \mathring{1} and \mathring{2}, the above intervals should be shorter than in \mathring{2} and \mathring{4} to save the consumption of high-temperature liquid to a necessary minimum.

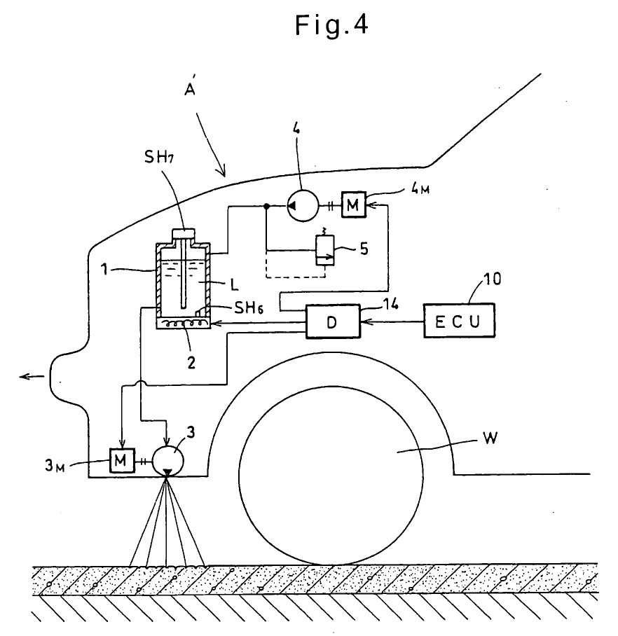

Now referring to FIG. 4, the slip-stop device A′ of the second embodiment is basically identical in structure to the first embodiment, except that the device A′ further includes a pressurizing pump 4 for pressurizing the liquid in the tank 1, a motor 4M for driving the pump 4, and a relief valve 5. While the tank 1 of the first embodiment is required only to be resistant to high temperatures and not to be so resistant to high pressure, the tank of the second embodiment has to be made of a material resistant to both high temperatures and high pressure for the obvious reasons. For example, the tank of the second embodiment is made of thick stainless steel.

The air in the tank 1 is pressurized to several to several tens of atms to increase the boiling point of the liquid, thereby making it possible to heat the liquid in the tank to a higher temperature without vaporizing. For example, while the boiling point of water is 100° C. at 1 atm, if the atmospheric pressure is increased to 15-20 atms, its boiling point increases to about 200° C. The boiling points of other liquids also increase by increasing the atmospheric pressure. Thus, in this embodiment, by sufficiently pressurizing the interior of the tank with the pump 4, the liquid in the tank, which may be water, can be heated to e.g. 200° C. by the heating coil 2 and sprayed by the pump 3.

Naturally, the higher the temperature of the liquid sprayed by the injection pump 3 in the form of discontinuous flows or droplets, the more efficiently such high-temperature flows or droplets of liquid can melt the ice covering the road surface. Thus, the device of the second embodiment can more efficiently and effectively increase the roughness of the road covered with ice. The pressurizing step using the pump 4 may be disposed after any of steps S3 to S6.

In the second embodiment, the first and second threshold temperatures t₁ and t₂ should be set at a higher level than in the first embodiment according to the boiling point reached by pressurizing the tank. Functionally, this embodiment is exactly the same as the first embodiment except that the tank is pressurized. The pressurizing means as well as the injection pump is kept deactivated to save energy while the ambient temperature, as measured through the ambient temperature sensor SH₁, is higher than a predetermined level.

In the second embodiment, instead of both pressurizing and heating the liquid in the tank, the heating coil 2 may be omitted to only pressurize, and not to heat, the liquid in the tank. In this case, the liquid should be pressurized to several tens of atms to scrape the ice covering the road surface with the pressurized liquid. A liquid sprayed under such a high pressure acts like hard rods hit hard against the ice and thus efficiently scrapes the ice.

In the second embodiment, if the liquid in the tank is only pressurized and not heated, the preheating steps, i.e. steps S3-S9 are not necessary and omitted. That is, the control circuit proceeds to step S10 when it determined that T_{A} is lower than T_{A1}.

In the embodiments, the control circuit determines whether the road surface is frozen based on temperature information from the ambient temperature sensor SH₁ and the road surface temperature sensor SH₂, and by detecting the friction coefficient between the road surface and the wheel based on information from the wheel speed sensor SH₄ and the acceleration sensor SH₅. But instead, this judgment may be made using the ambient temperature sensor SH₁ and means for detecting the friction coefficient between the road surface and the wheel other than the combination of the sensors SH₄ and SH₅.

Such means include a sensor that picks up information on the vibration of the wheel tire. Wheel tires usually vibrate at a resonance frequency while the vehicle is accelerating, decelerating or traveling at a constant speed on a high-μ road surface, but on a frozen road, their vibration frequencies tend to get out of the resonance frequency range. Thus, the control circuit can determine that the wheel is slipping and thus the road surface is frozen from the fact that the wheel tire is vibrating at a frequency outside the resonance frequency range. The road surface friction coefficient may also be inferred from the road surface contour or roughness, which is measurable by emitting e.g. ultrasonics, infrared rays, or laser beams on the road surface.

In the embodiments, a liquid is sprayed on the frozen road surface to roughen the road surface. But instead of a liquid, sand, seeds or any other granular material may be sprayed as disclosed in JP patent publication 8-25905. In this case, granular material may be heated and discharged through a discharge port under the pressure of compressed air pressurized by a compressor. In this arrangement, the injection pump is not used and thus omitted. Needless to say, granular material is discharged only if the control circuit 10 determines that the road surface is frozen.

In the embodiments, the control circuit determines whether the wheel is slipping and whether to spray liquid based on information from the brake pedal sensor, wheel speed sensor, and acceleration sensor. But one or some of these sensors may be omitted. Also, instead of or in addition to these sensors, a yaw rate sensor and/or any other known sensor that detects behaviors of a traveling vehicle may be used.

With the arrangement of the present invention, the friction coefficient between a frozen road surface and the particular wheel increases dramatically irrespective of whether the vehicle is being braked or not. Thus efficient acceleration, braking and traveling are ensured.

What is claimed is:

1. A slip-stop device for a vehicle comprising a tank in which is stored a liquid, a heater for heating the liquid in said tank to a high temperature, a sprayer provided near a road wheel of the vehicle for spraying the high-temperature liquid in discontinuous flows or droplets, a sensor unit for producing signals indicating the state of a road surface on which the vehicle is traveling, and a control unit for controlling said heater and said sprayer, said control unit being arranged to determine whether the road surface is frozen based on the signals from said sensor unit and, if the road surface is determined to be frozen, activate said sprayer to spray the high-temperature liquid on the road surface, thereby increasing the roughness of the road surface.

2. A slip-stop device for a vehicle comprising a tank in which is stored a liquid, a pressurizing unit for pressurizing the liquid in said tank to a high pressure, a sprayer provided near a road wheel of the vehicle for spraying the pressurized liquid in discontinuous flows or droplets, a sensor unit for producing signals indicating the state of a road surface on which the vehicle is traveling, and a control unit for controlling said pressurizing unit and said sprayer, said control unit being arranged to determine whether the road surface is frozen based on the signals from said sensor unit and, if the road surface is determined to be frozen, activate said sprayer to spray the pressurized liquid on the road surface, thereby increasing the roughness of the road surface.

3. A slip-stop device for a vehicle comprising a tank in which is stored a liquid, a pressurizing unit for pressurizing the liquid in said tank to a high pressure, a heater for heating the liquid to a high temperature, a sprayer provided near a road wheel of the vehicle for spraying the pressurized high-temperature liquid in discontinuous flows or droplets, a sensor unit for producing signals indicating the state of a road surface on which the vehicle is traveling, and a control unit for controlling said pressuring unit, said heater and said sprayer, said control unit being arranged to determine whether the road surface is frozen based on the signals from said sensor unit and, if the road surface is determined to be frozen, activate said sprayer to spray the pressurized high-temperature liquid on the road surface, thereby increasing the roughness of the road surface.

4. The slip-stop device as claimed in claim 1 further comprising an ambient temperature sensor for producing signals indicating an ambient temperature, said control unit being arranged to activate said heater only while the ambient temperature as detected based on the signals from said ambient temperature sensor is not more than a predetermined value.

5. The slip-stop device as claimed in claim 3 further comprising an ambient temperature sensor for producing signals indicating an ambient temperature, said control unit being arranged to activate said heater only while the ambient temperature as detected based on the signals from said ambient temperature sensor is not more than a predetermined value.

6. The slip-stop device as claimed in claim 2 further comprising an ambient temperature sensor for producing signals indicating an ambient temperature, said control unit being arranged to activate said pressurizing unit only while the ambient temperature as detected based on the signals from said ambient temperature sensor is not more than a predetermined value.

7. The slip-stop device as claimed in claim 3 further comprising an ambient temperature sensor for producing signals indicating an ambient temperature, said control unit being arranged to activate said pressurizing unit only while the ambient temperature as detected based on the signals from said ambient temperature sensor is not more than a predetermined value.

8. The slip-stop device as claimed in claim 1 wherein said sensor unit comprises a road surface temperature sensor for measuring the temperature of the road surface.

9. The slip-stop device as claimed in claim 2 wherein said sensor unit comprises a road surface temperature sensor for measuring the temperature of the road surface.

10. The slip-stop device as claimed in claim 3 wherein said sensor unit comprises a road surface temperature sensor for measuring the temperature of the road surface.

11. The slip-stop device as claimed in claim 1 wherein said sensor unit comprises an ambient temperature sensor and a sensor for measuring the friction coefficient of the road surface.

12. The slip-stop device as claimed in claim 2 wherein said sensor unit comprises an ambient temperature sensor and a sensor for measuring the friction coefficient of the road surface.

13. The slip-stop device as claimed in claim 3 wherein said sensor unit comprises an ambient temperature sensor and a sensor for measuring the friction coefficient of the road surface.

14. The slip-stop device as claimed in claim 1 wherein said sprayer includes a nozzle cap through which the liquid in the tank is sprayed in lines perpendicular to the direction in which the vehicle is traveling over an area on which the wheel passes.

15. The slip-stop device as claimed in claim 2 wherein said sprayer includes a nozzle cap through which the liquid in the tank is sprayed in lines perpendicular to the direction in which the vehicle is traveling over an area on which the wheel passes.

16. The slip-stop device as claimed in claim 3 wherein said sprayer includes a nozzle cap through which the liquid in the tank is sprayed in lines perpendicular to the direction in which the vehicle is traveling over an area on which the wheel passes.

17. The slip-stop device as claimed in claim 1 wherein said sensor unit includes a sensor for detecting behaviors of the vehicle.

18. The slip-stop device as claimed in claim 2 wherein said sensor unit includes a sensor for detecting behaviors of the vehicle.

19. The slip-stop device as claimed in claim 3 wherein said sensor unit includes a sensor for detecting behaviors of the vehicle.
